(19) United States
(12) Patent Application Publication
(10) Pub. No.: US 2020/0186678 A1
(43) Pub. Date: Jun. 11, 2020

(54) COLOR MANAGEMENT RESOURCE

(71) Applicant: HEWLETT-PACKARD DEVELOPMENT COMPANY, L.P., Spring, TX (US)

(72) Inventors: Miguel Angel Lopez, Vancouver, WA (US); David Berfanger, Vancouver, WA (US); Morgan T. Schramm, Vancouver, WA (US)

(73) Assignee: HEWLETT-PACKARD DEVELOPMENT COMPANY, L.P., Spring, TX (US)

(21) Appl. No.: 16/623,366

(22) PCT Filed: Jun. 15, 2017
(86) PCT No.: PCT/US2017/037770

§ 371 Date: Dec. 16, 2019

(51) Int. Cl. H04N 1/60

(52) U.S. Cl. CPC H04N 1/6058; H04N 1/6033

(57) ABSTRACT

A first number of color patches are printed with a target printing system to obtain a sparse color gamut characterization. A second number of color patches are printed with a reference printing system to obtain a reference color gamut characterization. The second number is greater than the first number. A dense color gamut characterization is generated with a transformation of the reference color gamut characterization to the sparse color gamut characterization. A color management resource can be generated for the target printing system from the dense color gamut characterization.

### BACKGROUND

Color management systems deliver a controlled conversion between color representations of various devices, such as image scanners, digital cameras, computer monitors, printers, and corresponding media. Device profiles provide color management systems with information to convert color data between color spaces such as between native device color spaces and device-independent color spaces, between device-independent color spaces and native device color spaces, and between source device color spaces and directly to target device color spaces.

### BRIEF DESCRIPTION OF THE DRAWINGS

FIG. 1 is a block diagram illustrating an example method.

FIG. 2 is a block diagram illustrating an example method to build a color management resource according to the method of FIG. 1.

FIG. 3 is a block diagram illustrating an example system to implement the example methods of FIGS. 1 and 2.

### DETAILED DESCRIPTION

A color space is a system having axes and that describes color numerically. Some output devices, such as printing devices, may employ a type of cyan-magenta-yellow-key (black) (CMYK) color space, while some software applications and display devices may employ a type of red-green-blue (RGB) color space. For example, a color represented in the RGB color space has a red value, a green value, and a blue value, and a color represented in the CMYK color space has a cyan value, a magenta value, a yellow value, and a key value, that combined numerically represent the color. A color gamut for a device is a property of the device that includes the range of color (and density/tonal values) that the device can produce as represented by a color space. A color gamut characterization can be obtained from measuring the colors produced with the device. Knowledge of the device color gamut characterization provides for the transfer of images or other color sensitive information among different devices with high color reproduction fidelity.

A color management resource is a set of data based on the color gamut characterization in a color space. A color profile is an example of color management resource. A color profile is a formal set of data that characterizes the color gamut in a color space. In one example, a color profile can describe the color attributes of a particular device or viewing specifications with a mapping between the device-dependent color space, such as a source or target color space, and a device-independent color space, such as profile connection space (PCS), and vice versa. The mappings may be specified using tables such as look up tables, to which interpolation is applied, or through a series of parameters for transformations. Devices and software programs—including printing devices, monitors, televisions, operating systems, browsers, and other devices and software—that capture or display color can include profiles that comprise various combinations of hardware and programming. An ICC profile is an example color profile that is a set of data that characterizes a color space according to standards promulgated by the International Color Consortium (ICC). Examples of this disclosure using ICC profiles, however, are for illustration only, and the description is applicable to other types of color profiles, color management resources, or color spaces.

The ICC profile framework has been used as a standard to communicate and interchange between various color spaces. An ICC output profile includes color table pairs, so-called A2B and B2A color look up tables, where A and B denote the device-dependent and the device-independent color spaces, respectively. For different devices, there are different look up table rendering intent pairs. For example, an ICC profile allows for three color table pairs, enumerated from 0 to 2, enabling the user to choose from one of the three possible rendering intents: perceptual, colorimetric, or saturation. ICC profiles are often embedded in color documents as various combinations of hardware and programming to achieve color fidelity between different devices. The size of color tables will increase with finer sampling of the spaces and larger bit depths.

Color tables that provide transformations between various color spaces are extensively used in color management, common examples being the transformations from device independent color spaces (such as CIELAB, i.e., L*a*b*) to device dependent color spaces (such as RGB or CMYK) and vice versa. The mappings may be specified using tables such as one or more single dimensional or multidimensional look-up tables, to which interpolation can be applied, or through a series of parameters for transformations. A color table can include an array or other data structure stored on a memory device that replaces runtime computations with a simpler array indexing operation as a color look-up table. For the purposes of this disclosure, color tables can also include monochromatic and gray scale color tables.

Printing devices—including printers, copiers, fax machines, multifunction devices including additional scanning, copying, and finishing functions, all-in-one devices, pad printers to print images on three dimensional objects, and three-dimensional printers (additive manufacturing devices)—employ color management systems to deliver a controlled conversion between color representations of various devices, such as image scanners, digital cameras, computer monitors, printers, and software applications. In one example, printing devices often employ color tables including multidimensional color look-up tables to provide transformations between different color spaces such as from input device-independent colors to CMYK colorant amounts for printing on media or, in the case of three dimensional printing devices, printing agent amounts for printing on a powder or other material. For example, a three dimensional printing device can employ an ICC profile to “soft proof” or predict a color output of an article before the article is printed. For devices such as color printers or other printing devices, the color tables can be embedded in memory devices storing the printer firmware or other hardware. In some examples, the color transform may be colorant-dependent, such as dependent on the particular formulation of the printing liquid included in a supply component such as a cartridge, information regarding the color gamut characterization can be stored on a memory device located on the cartridge for use with the printing device such as its firmware or other hardware.

In one example, a color table environment such as a printing device may include a plurality of multidimensional color tables that can correspond to substrates, rendering intents, and colorant axes of a color gamut, among other things, included in a color profile. In general, a profile can include N color tables to be processed, such as CLUT₁, CLUT₂, . . . , CLUT_{N}, and the input color space includes Jᵢₙ channels. In one example, multiple color tables representing different rendering intents can be included with one ICC profile. Additionally, the output color space includes Jₒᵤₜ channels, and in many examples of an ICC profile Jᵢₙ and Jₒᵤₜ can be 3 or 4 channels. For each output channel, the corresponding lookup table contains M^{J}^{ᵢₙ} nodes. For example, each color table can include M⁴ nodes for each of the C, M, Y, and K four colorants corresponding with each ink color used in the printing device or M³ nodes for each of the R, G, and B three primaries corresponding with each primary color used in the display device. Additionally, each type of substrate used in the printing device can include a set of color tables.

A color gamut characterization for a printing device has been generated from printing and measuring a dense color target on a given substrate with the inks of the printing device. As used in this disclosure, a substrate is a superset of print media, such as plain paper, and can include any suitable object or materials to which printing agents or colorants from a printing device are applied including materials, such as powdered build materials, for forming three-dimensional articles. Printing agents and colorants are a superset of inks and can include toner, liquid inks, or other suitable marking material that that may or may not be mixed with fusing agents, detailing agents, or other materials and can be applied to the substrate. Typically, a dense color target includes over 700 different printed color patches on the substrate in order to obtain an relatively accurate ICC profile (9×9×9 RGB data lattice), and color targets with over 4,000 printed color patches are not unusual (17×17×17 RGB data lattice). The printed color patches are generally of a size that can be effectively measured with a colorimeter or spectrophotometer, and the printed color patches usually consume a large amount of substrate.

A common approach to the process of color gamut characterization is laborious and can be expensive. Addressing issues such as noise and multiple parameters in two-dimensional printing devices can produce hundreds of pages of color patches that are managed and coalesced into color mapping tools. Further, color mapping can be highly iterative that involve multiple attempts to generate acceptable results. A few iterations of the process can produce over a thousand pages of color patches. In the case of three-dimensional printing devices, the larger number of parameter values that can affect color reproduction as well as longer build times of three-dimensional objects can significantly exacerbate these issues. An iterative process for a three-dimensional printing device may take months to complete.

In order to alleviate the labor and expense, manufacturers have attempted to generate color management resources, such as color profiles, from printing and measuring a significantly less number of color patch samples than typically used to generate an accurate profile, and then interpolating the remaining color gamut characterization from the samples. Such an approach, however, tends to yield unsatisfactory results. For example, standard linear interpolation of the samples provides an approximation of the dense color gamut characterization that is not particularly accurate. Also, while higher order interpolation methods, such as spline interpolation, can improve accuracy, higher order interpolation methods can also be unstable and produce regions of high error.

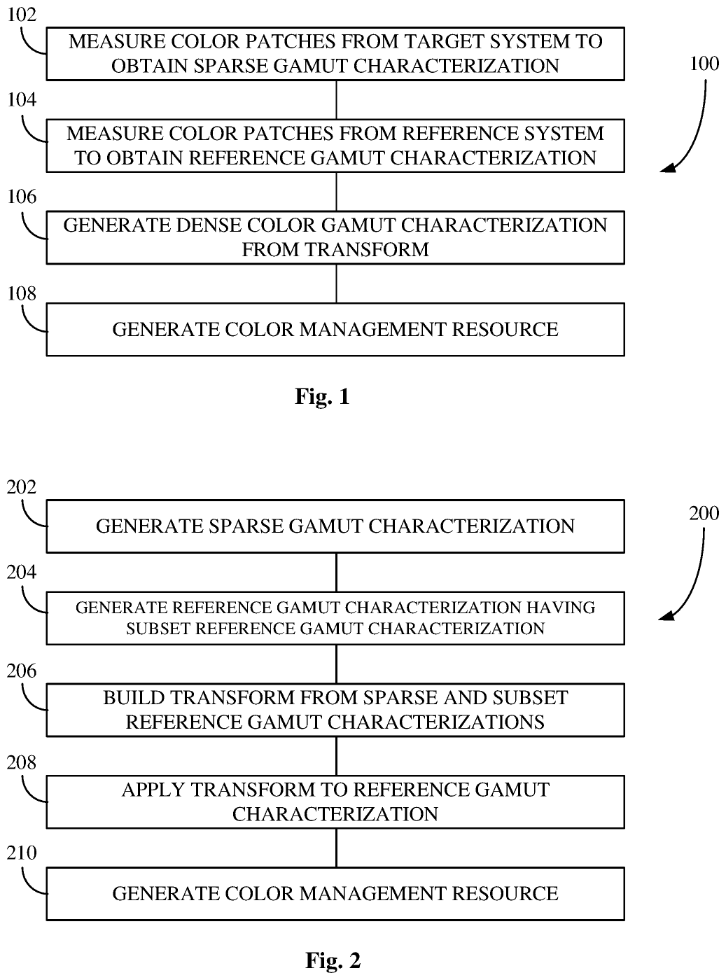

FIG. 1 illustrates an example method 100 for creating a color management resource, such as color profile or other set of color management data. A first number of color patches are printed with a target printing system to obtain a sparse color gamut characterization at 102. A second number of color patches are printed with a reference printing system to obtain a reference color gamut characterization at 104. The second number of color patches is greater than the first number of color patches. A dense color gamut characterization is generated with a transformation of the reference color gamut characterization to the sparse color gamut characterization at 106. A color management resource can be generated for the target printing system from the dense color gamut characterization at 108. In one example, the color gamut characterizations are provided as coordinates in a device-independent color space.

Printing and measuring the relatively smaller first number of color patches can significantly reduce the time and effort applied in obtaining a usable sample for color mapping the target printing system. Further, allowing the response of the reference printing system to be used as a proxy for the target printing system significantly improves the speed of the process, and enables the possibility of performing precise color mapping calibrations in the field.

The target printing system and the reference printing system can each include a selected configuration. The configurations for each of the target printing system and the reference printing system can include a selected printing device with selected printing agents or colorants for selected substrates in a selected set of conditions. The target printing system and the reference printing system can include one or some of the same configuration such as the device, printing agents or colorants, substrates, and conditions. For example, the printing device or colorant from the target printing system can be the same as the printing device or colorant from the reference printing system. In another example, the target printing system and the reference printing system can be identical but operate under different conditions, such as three-dimensional printing the same part surface at different orientations. In still another example used as illustration in the disclosure, the target printing system can include a three-dimensional printing device applying printing agents to a white polyamide powder substrate and the reference printing system can include a two-dimensional printing device applying a colorant to a plain paper substrate. The colorant may be included in the printing agents. Other examples of similarities and differences between the configurations of the target printing system and reference printing system can be illustrated throughout the disclosure.

In one example, the first number of color patches are printed with selected control values as data provided to the target printing system at 102. For example, each color patch is printed using a selected set of coordinates in a color space, such as RGB, provided to the target printing system. A subset of the second number of color patches are printed with the selected control values provided to the reference printing system to obtain a subset of the reference color gamut characterization at 104. For example, each color patch in the subset is printed using the selected set of coordinates in the color space provided to the reference printing system. In one example, the control values are provided as coordinates in a device dependent color space. The sparse color gamut characterization and the subset of the reference color gamut characterization are applied to develop a transform, which can be applied to the reference color gamut characterization to obtain the dense color gamut characterization at 106.

FIG. 2 illustrates an example method 200 to implement method 100. A first number of target color patches are printed with selected control data applied to a target printing system and measured to obtain a sparse color gamut characterization at 202. A second number of reference color patches are printed with a reference printing system and measured to obtain a reference color gamut characterization at 204. The reference color patches include a subset of reference color patches that are printed with the selected control data applied to the reference printing system. The reference color gamut characterization includes a subset reference color gamut characterization that is obtained according to the measurements from the subset of reference color patches. A transform is built with the subset of reference color gamut characterization to the sparse color gamut characterization at 206. The transform is applied to the reference color gamut characterization to obtain the dense color gamut characterization at 208. A color management resource, such as a color profile document or ICC profile, can be built from the dense color gamut characterization at 210.

The first number of target color patches are printed with the selected control data applied to the target printing system and measured to obtain the sparse color gamut characterization at 202. Method 200 does not set out particular number for the first number of sparse color patches. Further, method 200 does not set out a particular correspondence of the sparse color patches to a color gamut of the target printing system. In one example, the target color patches can make up a convex hull of the color gamut for the target printing system and can include at least some of the more chromatic colors of the color gamut. In another example, used in this disclosure for illustration, the first number of target color patches can include a selected twenty-seven target color patches corresponding to a selected 3×3×3 RGB sampling, which can be provided as input control data to the target printing system. Other input data, such as CMYK values can be used. The color patches of the target printing system can include a three-dimension article if the target printing system includes a three-dimensional printing device or a two-dimensional color patch on a flat substrate if the target printing system includes a two-dimensional printing device. Other configurations are possible.

The first number of target color patches in the example are printed with a selected set of control data provided to the target printing system. For example, each target color patch is printed as a result of selected control values provided to the target printing system as input coordinates in a color space, such as a device-dependent color space including RGB. The input coordinates can be arranged in an input target matrix in which each row of the first number of rows represents a printed target color patch and each column represents an input coordinate of in the color space. In the illustrated example, an input target matrix would include twenty-seven rows each corresponding with one of the twenty- seven printed target color patches and each column would correspond with a coordinate in RGB color space for that printed target color patch. The input target matrix can be provided as an array or other data structure in a computer memory.

The target color patches printed with the target printing system can be measured with a spectrophotometer or other device to obtain measurement values as data. The measurement values can be provided as color coordinates in a color space, such as a device-independent color space including CIE 1976 L*a*b* data. The measured coordinates can be arranged in a measured target matrix in which each row of the first number of rows represents a measured target color patch and each column represents a color coordinate for that measured target color patch. In the illustrated example, a measured target matrix would include twenty-seven rows each corresponding with one of the twenty-seven measured color patches and each column in that row would correspond with L*a*b* coordinates for that target color patch. The measured target matrix can be stored as a data structure in a computer memory.

A model of a target system could be represented as

[L*_{fs}, a*_{fs}, b*_{fs}]=fₛ(Rₛ, Gₛ, Bₛ)

in which the function fs could be defined as a trivariate target lookup table having a node corresponding with a row in the measured target matrix. In one example, the first number of nodes may not provide sufficiently accurate modeling for colors of the gamut between the nodes of the target lookup table, i.e., standard interpolating techniques do not provide sufficient modeling for colors between the nodes. The model and lookup table can be implemented, for example, as a data structure, such as an array, stored on a computer memory device. In one example, the model and lookup table are stored in a computer memory device as the sparse color gamut characterization.

The second number of reference color patches are printed with the reference printing system and measured to obtain the reference color gamut characterization at 204. Again, method 200 does not set out particular number of reference color patches for the second number of reference color patches. The color patches of the target system or the color patches of the reference system can be printed using a uniform convex sampling of the corresponding device color space. As an illustrated example, the reference printing system can produce 729 color patches corresponding to a 9×9×9 RGB sampling, which can be provided as input values to the reference printing system. (In another example, 4,913 color patches can be printed corresponding to a 17×17×17 RGB sampling.) In an illustrated example, the reference printing system can produce the color patches on plain paper with a two-dimensional printer. In this example, the type or formulation of the printing agents or colorants used in the target printing system are used in the reference printing system.

The second number of reference color patches in the example are also printed with a reference set of control data provided to the reference printing system, in a manner similar to the sparse color patches. For example, each reference color patch is printed as a result of reference control values provided to the reference printing system as input coordinates in a color space, such as RGB. The input coordinates can be arranged in an input reference matrix in which each row of the second number of rows represents a printed reference color patch and each column represents an input coordinate of in the color space. In the illustrated example, an input reference matrix would include 729 rows each corresponding with one of the 729 printed reference color patches and each column of that row would correspond with a coordinate in RGB color space for that printed reference color patch. The input reference matrix can be stored as a data structure in a computer memory.

The reference control data can include the target control data. In the illustrated example, the set of 729 printed reference color patches include a subset of twenty-seven reference color patches printed with the RGB input coordinates of the input target matrix.

The reference color patches printed with the reference printing system can be measured with a spectrophotometer or other device to obtain measurement values as data, as described for the target color patches. The measurement values can be provided as color coordinates in a color space, such as CIELAB data. The measured coordinates can be arranged in a measured reference matrix in which each row of the first number of rows represents a measured reference color patch and each column represents a color coordinate. In the illustrated example, a measured reference matrix would include 729 rows each corresponding with one of the 729 measured reference color patches and each column in that row would correspond with L*a*b* coordinates for that reference color patch. The measured reference matrix can be stored as a data structure in a computer memory.

A model of a reference system could be represented as

[L*ₕᵣ, a*ₕᵣ, b*ₕᵣ]=hᵣ(Rᵣ, Gᵣ, Bᵣ)

in which the function hr could be defined as a trivariate reference lookup table having a node corresponding with a row in the reference matrix. In one example, the second number of nodes preferably provides sufficiently accurate modeling for colors between the nodes of the reference lookup table. The model and lookup table can be implemented, for example, as a data structure, such as an array, stored on a computer memory device. In one example, model and lookup table are stored in a computer memory device as the reference color gamut characterization.

The reference color patches include a subset of reference color patches that are printed with the selected set of control data applied to the reference printing system, e.g., the same selected set of control data applied to the target printing system to obtain the target color patches. In the illustrated example, the subset of reference color patches includes those twenty-seven reference color patches that are printed with the same input RGB coordinates that were provided to the target printing system to obtain the target color patches. The subset of the measured reference matrix corresponding with the reference color patches printed with the selected set of control data is the subset of reference color gamut characterization. In the notation of the models above, this reference subset of control values can be represented as

[L*ₕₛ, a*ₕₛ, b*ₕₛ]=hᵣ(Rₛ, Gₛ, Bₛ).

A transform is built with the subset of reference color gamut characterization to the sparse color gamut characterization at 206. Various techniques can be applied to generate the transform, such as a cellular interpolation scheme, linear, polynomial or splines interpolation, regression, or other technique and can employ linear or non-linear machine learning processes. Accommodations can be made for inter-dimensional cross dependencies. In one example, the transform T can be represented as

T=inv(X^{t}X)X^{t}Y

in which Y represents a matrix of the coordinates of the sparse color gamut characterization as measured in 202, i.e., the measured target matrix (e.g., the twenty-seven CIELAB values from the measured target matrix), X represents a matrix of the coordinates of the subset of reference color gamut characterization as measured in 204, i.e., the subset of the measured reference matrix (e.g. the twenty-seven CIELAB values from the subset of the measured reference matrix), inv represents matrix inversion, and superscript t represents matrix transpose. The inv(X^{t}X)X^{t} in the example is a Moore-Penrose pseudoinverse X⁺ or pinv(X), which is a generalization of the inverse matrix, and may be incorporated into a linear feed-forward neural network or a linear project pursuit regression, for example. The pinv(X) can be computed via singular decomposition rather than algebraic methods to enhance numerical stability.

The transform is applied to the reference color gamut characterization to obtain the dense color gamut characterization at 208. For example, the transform T as determined from 206 can be applied to the entire set of the reference color gamut characterization, such as the 729 CIELAB values from the measured reference matrix. In one example, the applied transform creates a dense color gamut characterization that can include 729 CIELAB values as data from the 729 CIELAB values of the reference color gamut characterization that can represent the color gamut characterization of the target printing system.

A color management resource for use with the target printing system can be built from the dense color gamut characterization at 210. In one example, the color management resource can be included as part of a color profile for the target printing system.

The example methods 100, 200 can be implemented to include a combination of one or more hardware devices and programs for controlling a system, such as a computing device having a processor and memory, to perform methods 100, 200 to generate a color management resource. For example, methods 100, 200 can be implemented as a set of executable instructions stored in a computer memory device for controlling the processor. A color management resource, as well as color gamut characterizations used to generate the color management resource, can include an array or other data structure on a memory device that replaces runtime computations with a simpler array indexing operation as a color look up table.

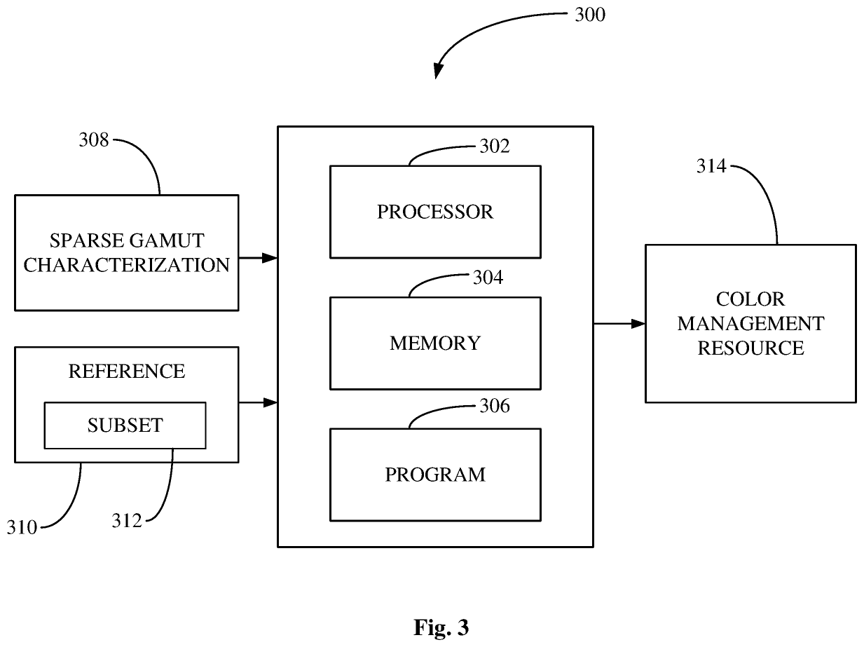

FIG. 3 illustrates an example system 300 including a computing device 302 having a processor 304 and memory 306 and program 308 to implement example methods 100, 200. Program 308 can be implemented as a set of processor-executable instructions stored on a non-transitory computer readable medium. Computer readable media, computer storage media, or memory may be implemented to include a combination of one or more volatile or nonvolatile computer storage media or as any suitable method or technology for storage of information such as computer readable instructions, data structures, program modules or other data. A propagating signal by itself does not qualify as storage media or a memory device.

System 300 is configured to receive a sparse color gamut characterization 310. Additionally, system 300 is configured to receive a reference color gamut characterization 312, which can include a subset of the reference color gamut characterization 314. System 300 is configured to implement methods 100, 200 and generate a color management resource 316. Color gamut characterization 310, 312, 314, and color management resource 316 can be provided as a data structure on a computer readable medium. In one example, the color management resource 316 is included on a memory device that can be operably coupled to the target printing device, such as software or firmware of the target printing device, or as part of a supply component operably coupled to the target printing device such as an ink cartridge or other part for use with the target printing device.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method, comprising:
measuring a first number of color patches printed with a target printing system to obtain a sparse color gamut characterization;
measuring a second number of color patches printed with a reference printing system to obtain a reference color gamut characterization, wherein the second number is greater than the first number;
generating a dense color gamut characterization with a transformation of the reference color gamut characterization to the sparse color gamut characterization; and
generating a color management resource for the target printing system according to the dense color gamut characterization.

2. The method of claim 1 wherein the first number of color patches are printed on a first substrate and the second number of colors are printed on a second substrate.

3. The method of claim 1 wherein the colorants for the first number of color patches and the second number of color patches are of a same formulation.

4. The method of claim 1 wherein the first number color patches are printed with the target printing system via a uniform convex sampling of a color gamut of the target system and the second number of color patches are printed via a uniform convex sampling of a color gamut of the reference system.

5. The method of claim 1 wherein the target printing system includes a three-dimensional printing device and the reference printing system includes a two-dimensional printing device.

6. The method of claim 1 wherein the color management resource is included in a color profile.

7. The method of claim 1 wherein the target printing system includes a three-dimensional printing device operating under a first condition and the reference printing system includes the three-dimensional printing device operating under a second condition wherein the first condition is different from the second condition.

8. A method, comprising:
generating a sparse color gamut characterization from a first number of target color patches printed with selected control data applied to a target printing system;
generating a reference color gamut characterization from a second number of reference color patches printed with a reference printing system, wherein the reference color gamut characterization includes a subset reference color gamut characterization;
building a transform of the subset of reference color gamut characterization to the sparse color gamut characterization;
applying the transform to the reference color gamut characterization to obtain a dense color gamut characterization; and
generating a color management resource from the dense color gamut characterization.

9. The method of claim 8 wherein the subset of the reference gamut color characterization is obtained from a subset of reference color patches.

10. The method of claim 9 wherein the target color patches and the subset of reference color patches are printed using selected control data.

11. The method of claim 10 wherein the selected control data includes color coordinates provided to the target printing system and the reference printing system.

12. The method of claim 11 wherein the color coordinates are in a device-dependent color space and the color gamut characterizations are provided as coordinates in a device-independent color space.

13. A system, comprising:
a memory to store a set of instructions; and
a processor to execute the set of instructions to:
receive a sparse color gamut characterization obtained from a first number of color patches printed with a target printing system;
receive a reference color gamut characterization obtained from a second number of color patches printed with a reference printing system,
wherein the second number is greater than the first number;
generate a dense color gamut characterization with a transformation of the reference color gamut characterization to the sparse color gamut characterization; and
generate a color management resource for the target printing system according to the dense color gamut characterization.

14. The system of claim 13 wherein the color management resource is provided on a memory device.

15. The system of claim 13 wherein the memory device is operably couplable to the target printing system.
